(19) United States
(12) Patent Application Publication
(10) Pub. No.: US 2007/0197689 A1
(43) Pub. Date: Aug. 23, 2007

(54) Additive building material mixtures containing nonionic emulsifiers

(75) Inventors: Holger Kautz, Hanau (DE); Jan Hendrik Schattka, Hanau (DE); Gerd Lohden, Hanau (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Rohm GmbH & Co. KG, Darmstadt (DE)

(21) Appl. No.: 11/387,976

(22) Filed: Mar. 24, 2006

(30) Foreign Application Priority Data
Feb. 23, 2006 (DE) 102006008970.7

(51) Int. Cl. C09D 5/14

(52) U.S. Cl. 524/2

(57) ABSTRACT

The present invention relates to the use of polymeric microparticles containing nonionic emulsifiers in hydraulically setting building material mixtures for the purpose of enhancing their frost resistance and cyclical freeze/thaw durability.

Additive building material mixtures containing nonionic emulsifiers The present invention relates to the use of polymeric microparticles in hydraulically setting building material mixtures for the purpose of enhancing their frost resistance and cyclical freeze/thaw durability.

Concrete is an important building material and is defined by DIN 1045 (July 1988) as artificial stone formed by hardening from a mixture of cement, aggregate and water, together where appropriate with concrete admixtures and concrete additions. One way in which concrete is classified is by its subdivision into strength groups (BI-BII) and strength classes (B5-B55). Adding gas-formers or foam-formers to the mix produces aerated concrete or foamed concrete (Römpp Lexikon, 10th ed., 1996, Georg Thieme Verlag).

Concrete has two time-dependent properties. Firstly, by drying out, it undergoes a reduction in volume that is termed shrinkage. The majority of the water, however, is bound in the form of water of crystallization. Concrete, rather than drying, sets: that is, the initially highly mobile cement paste (cement and water) starts to stiffen, becomes rigid, and, finally, solidifies, depending on the timepoint and progress of the chemical/mineralogical reaction between the cement and the water, known as hydration. As a result of the water-binding capacity of the cement it is possible for concrete, unlike quicklime, to harden and remain solid even under water. Secondly, concrete undergoes deformation under load, known as creep.

The freeze/thaw cycle refers to the climatic alternation of temperatures around the freezing point of water. Particularly in the case of mineral-bound building materials such as concrete, the freeze/thaw cycle is a mechanism of damage. These materials possess a porous, capillary structure and are not watertight. If a structure of this kind that is full of water is exposed to temperatures below 0° C., then the water freezes in the pores. As a result of the density anomaly of water, the ice then expands. This results in damage to the building material. Within the very fine pores, as a result of surface effects, there is a reduction in the freezing point. In micropores water does not freeze until below −17° C. Since, as a result of freeze/thaw cycling, the material itself also expands and contracts, there is additionally a capillary pump effect, which further increases the absorption of water and hence, indirectly, the damage. The number of freeze/thaw cycles is therefore critical with regard to damage.

Decisive factors affecting the resistance of concrete to frost and to cyclical freeze/thaw under simultaneous exposure to thawing agents are the imperviousness of its microstructure, a certain strength of the matrix, and the presence of a certain pore microstructure. The microstructure of a cement-bound concrete is traversed by capillary pores (radius: 2 μm-2 mm) and gel pores (radius: 2-50 nm). Water present in these pores differs in its state as a function of the pore diameter. Whereas water in the capillary pores retains its usual properties, that in the gel pores is classified as condensed water (mesopores: 50 nm) and adsorptively bound surface water (micropores: 2 nm), the freezing points of which may for example be well below −50° C. [M. J. Setzer, Interaction of water with hardened cement paste, Ceramic Transactions 16 (1991) 415-39]. Consequently, even when the concrete is cooled to low temperatures, some of the water in the pores remains unfrozen (metastable water). For a given temperature, however, the vapor pressure over ice is lower than that over water. Since ice and metastable water are present alongside one another simultaneously, a vapor-pressure gradient develops which leads to diffusion of the still-liquid water to the ice and to the formation of ice from said water, resulting in removal of water from the smaller pores or accumulation of ice in the larger pores. This redistribution of water as a result of cooling takes place in every porous system and is critically dependent on the type of pore distribution.

The artificial introduction of microfine air pores in the concrete hence gives rise primarily to what are called expansion spaces for expanding ice and ice-water. Within these pores, freezing water can expand or internal pressure and stresses of ice and ice-water can be absorbed without formation of microcracks and hence without frost damage to the concrete. The fundamental way in which such air-pore systems act has been described, in connection with the mechanism of frost damage to concrete, in a large number of reviews [Schulson, Erland M. (1998) Ice damage to concrete. CRREL Special Report 98-6; S. Chatterji, Freezing of air-entrained cement-based materials and specific actions of air-entraining agents, Cement & Concrete Composites 25 (2003) 759-65; G. W. Scherer, J. Chen & J. Valenza, Methods for protecting concrete from freeze damage, U.S. Pat. No. 6,485,560 B1 (2002); M. Pigeon, B. Zuber & J. Marchand, Freeze/thaw resistance, Advanced Concrete Technology 2 (2003) 11/1-11/17; B. Erlin & B. Mather, A new process by which cyclic freezing can damage concrete—the Erlin/Mather effect, Cement & Concrete Research 35 (2005) 1407-11].

A precondition for improved resistance of the concrete on exposure to the freezing and thawing cycle is that the distance of each point in the hardened cement from the next artificial air pore does not exceed a defined value. This distance is also referred to as the “Powers spacing factor” [T. C. Powers, The air requirement of frost-resistant concrete, Proceedings of the Highway Research Board 29 (1949) 184-202]. Laboratory tests have shown that exceeding the critical “Power spacing factor” of 500 μm leads to damage to the concrete in the freezing and thawing cycle. In order to achieve this with a limited air-pore content, the diameter of the artificially introduced air pores must therefore be less than 200-300 μm [K. Snyder, K. Natesaiyer & K. Hover, The stereological and statistical properties of entrained air voids in concrete: A mathematical basis for air void systems characterization, Materials Science of Concrete VI (2001) 129-214].

The formation of an artificial air-pore system depends critically on the composition and the conformity of the aggregates, the type and amount of the cement, the consistency of the concrete, the mixer used, the mixing time, and the temperature, but also on the nature and amount of the agent that forms the air pores, the air entrainer. Although these influencing factors can be controlled if account is taken of appropriate production rules, there may nevertheless be a multiplicity of unwanted adverse effects, resulting ultimately in the concrete's air content being above or below the desired level and hence adversely affecting the strength or the frost resistance of the concrete.

Artificial air pores of this kind cannot be metered directly; instead, the air entrained by mixing is stabilized by the addition of the aforementioned air entrainers [L. Du & K. J. Folliard, Mechanism of air entrainment in concrete, Cement & Concrete Research 35 (2005) 1463-71]. Conventional air entrainers are mostly surfactant-like in structure and break up the air introduced by mixing into small air bubbles having a diameter as far as possible of less than 300 μm, and stabilize them in the wet concrete microstructure. A distinction is made here between two types.

One type—for example sodium oleate, the sodium salt of abietic acid or Vinsol resin, an extract from pine roots—reacts with the calcium hydroxide of the pore solution in the cement paste and is precipitated as insoluble calcium salt. These hydrophobic salts reduce the surface tension of the water and collect at the interface between cement particle, air and water. They stabilize the microbubbles and are therefore encountered at the surfaces of these air pores in the concrete as it hardens.

The other type—for example sodium lauryl sulfate (SDS) or sodium dodecyl-phenylsulphonate —reacts with calcium hydroxide to form calcium salts which, in contrast, are soluble, but which exhibit an abnormal solution behavior. Below a certain critical temperature the solubility of these surfactants is very low, while above this temperature their solubility is very good. As a result of preferential accumulation at the air/water boundary they likewise reduce the surface tension, thus stabilize the microbubbles, and are preferably encountered at the surfaces of these air pores in the hardened concrete.

The use of these prior-art air entrainers is accompanied by a host of problems [L. Du & K. J. Folliard, Mechanism of air entrainment in concrete, Cement & Concrete Research 35 (2005) 1463-71. For example, prolonged mixing times, different mixer speeds and altered metering sequences in the case of ready-mix concretes result in the expulsion of the stabilized air (in the air pores).

The transporting of concretes with extended transport times, poor temperature control and different pumping and conveying equipment, and also the introduction of these concretes in conjunction with altered subsequent processing, jerking and temperature conditions, can produce a significant change in an air-pore content set beforehand. In the worst case this may mean that a concrete no longer complies with the required limiting values of a certain exposure class and has therefore become unusable [EN 206-1 (2000), Concrete-Part 1: Specification, performance, production and conformity].

The amount of fine substances in the concrete (e.g. cement with different alkali content, additions such as flyash, silica dust or color additions) likewise adversely affects air entrainment. There may also be interactions with flow improvers that have a defoaming action, and hence expel air pores, but may also introduce them in an uncontrolled manner.

A further perceived disadvantage of the introduction of air pores is that the mechanical strength of the concrete decreases as the air content goes up.

All of these influences which make it more difficult to produce frost-resistant concrete can be avoided if the air pore system required is generated not through the aforementioned air entrainers of surfactant-like structure, but if, instead, the air content comes about through the admixing or solid metering of polymeric microparticles (hollow microspheres) [H. Sommer, A new method of making concrete resistant to frost and de-icing salts, Betonwerk & Fertigteiltechnik 9 (1978) 476-84]. Since the microparticles generally have particle sizes of less than 100 μm, they can also be distributed more finely and uniformly in the concrete microstructure than can artificially introduced air pores. Consequently, even small amounts are sufficient for sufficient resistance of the concrete to the freezing and thawing cycle.

The use of polymeric microparticles of this kind for improving the frost resistance and cyclical freeze/thaw durability of concrete is already known from the prior art [cf. DE 2229094 A1, U.S. Pat. No. 4,057,526 B1, U.S. Pat. No. 4,082,562 B1, DE 3026719 A1]. The microparticles described therein have diameters of at least 10 μm (typically much larger) and possess air-filled or gas-filled voids. This likewise includes porous particles which may be larger than 100 μm and may possess a multiplicity of relatively small voids and/or pores.

In connection with the use of hollow microparticles for artificial air entrainment in concrete, two factors have proven detrimental to the establishment of this technology on the market. On the one hand, the production costs of hollow microspheres in accordance with the Prior art are too high, and on the other hand satisfactory resistance of the concrete toward freezing and thawing cycles is achievable only with relatively high added amounts. The object on which the present invention is based, therefore, was to provide a means of improving the frost resistance and cyclical freeze/thaw durability for hydraulically setting building material mixtures that develops its full activity even at relatively low levels of addition. A further object was not, or not substantially, to affect the mechanical strength of the hardened construction mixture as a result of said means.

This object has been achieved through the use of polymeric microparticles, containing a void, in hydraulically setting building material mixtures, characterized in that the microparticles are stabilized by nonionic emulsifiers.

Surprisingly it has been found that by means of nonionic emulsifiers it has proven possible to achieve a marked reduction in the foaming propensity not only in the dispersion but also in the building material mixture.

A reduced foaming propensity is of advantage because it entrains less air into the building material mixtures, which leads in turn to a lower level of impairment of the mechanical strength of the fully hardened building material mixture.

Nonionic emulsifiers are surface-active substances (surfactants) having an uncharged group(s) which in the neutral pH range carries no ionic charge and which is polar, hydrophilic, and water-solubilizing, and which adsorbs on interfaces and, above the critical micelle concentration, undergoes aggregation to form neutral micelles.

The nonionic emulsifiers used are selected preferably from the group of emulsifiers whose hydrophilic group(s) belong to the alcohols, amine oxides, or (oligo)oxyalkylenes or mixtures thereof.

Preference is given from the alcohol group to the alkylpolyglucosides, sucrose esters, sorbitol esters, acetylenediols, alkanediols, and fatty acid N-methyl-glucamides.

Preference from the group of the amine oxides is given to the alkyldimethyl-amine oxides.

Particular preference from the (oligo)oxyalkylene group is given to the (oligo)oxyethylene groups (polyethylene glycol groups). These include, in particular, fatty alcohol polyglycol ethers (fatty alcohol ethoxylates), alkylphenol polyglycol ethers, and also fatty acid ethoxylates, fatty amine ethoxylates, ethoxylated triglycerides, and mixed ethers (polyethylene glycol ethers with alkylation at both ends).

In the case of macromolecular emulsifiers there are numerous possibilities for arranging one or more hydrophilic blocks. Preference is given here to the use of block copolymers.

The block copolymers employed in accordance with the invention (the term block copolymer stands here for polymers whose molecules are composed of linked blocks, preferably linearly linked blocks, the blocks being connected directly to one another and the term block referring to a section of a polymer molecule that comprises two or more monomeric units which possess at least one common feature that does not occur in the immediately adjacent sections) may be diblock copolymers, triblock copolymers or else multiblock copolymers encompassing more than three blocks. Preferably they are noncrosslinked. If a polymer block of type A is symbolized A and a polymer block of type B is symbolized B, and disregarding initiator residues, any moderator residues, and termination residues, then examples of block copolymers which can be employed in accordance with the invention suitably include the following: linear systems such as A-B, A-B-A, B-A-B or (A-B)ₙ, star-shaped systems such as A(B)ₙ, B(A)ₙ or (A)ₙ-B-A-(B)ₘ, dendrimeric systems such as ((A)ₙ-B)ₘA, ((B)ₙ-A)ₘB, (((A)ₘ-B)ₙA)ₚB or (((B)ₘ-A)ₙB)ₚA or comb-shaped systems such as ((A)ₙ-A(B))_{q}, or ((B)ₙ-B(A))_{q}, where m, n, p, and q symbolize integers greater than 1.

Examples of hydrophobic blocks are poly(propylene oxide), poly(siloxanes) and poly(alkane)s.

The nonionic emulsifiers of the invention are used in amounts of <5% by weight, with particular preference of <3% by weight, and most preferably <1% by weight, based on the polymer content of the microparticles.

The microparticles of the invention can be prepared preferably by emulsion polymerization and preferably have an average particle size of 100 to 5000 nm; an average particle size of 200 to 2000 nm is particularly preferred. Most preferable are average particle sizes of 250 to 1000 nm.

The average particle size is determined, for example, by counting a statistically significant amount of particles by means of transmission electron micrographs.

In the case of preparation by emulsion polymerization the microparticles are obtained in the form of an aqueous dispersion. Accordingly, the addition of the microparticles to the building material mixture preferably takes place likewise in this form with nonionic emulsifiers, in particular, being included in the dispersion.

In connection with the microparticles employed in accordance with the invention, nonionic emulsifiers are added to the dispersion during or after the preparation.

Microparticles of this kind are already known in accordance with the prior art and are described in publications EP 22 633 B1, EP 73 529 B1, and EP 188 325 B1. Furthermore, these microparticles are sold commercially under the brand name ROPAQUE® by the company Rohm & Haas. These products were hitherto used primarily in inks and paints for the purpose of improving the hiding power and light impermeability (opacity) of coatings or prints on paper, boards, and other materials.

At the preparation stage and in the dispersion, the voids of the microparticles are water-filled. Without restricting the invention to this effect, it is assumed that the water is lost by the particles during setting of the building material mixture, at least partly, after which, correspondingly, gas-filled or air-filled hollow spheres are present.

This process also takes place, for example, when such microparticles are used in paints.

According to one preferred embodiment the microparticles used are composed of polymer particles which possess a polymer core (A), swollen by means of an aqueous base, and at least one polymer envelope or shell (B).

The core (A) of the particle contains one or more ethylenically unsaturated carboxylic acid (derivative) monomers which permits swelling of the core; these monomers are preferably selected from the group of acrylic acid, methacrylic, maleic acid, maleic anhydride, fumaric acid, itaconic acid, and crotonic acid, and mixtures thereof. Acrylic and methacrylic acid are particularly preferred.

The shell (B) is composed predominantly of nonionic, ethylenically unsaturated monomers. Preferred such monomers used include styrene, butadiene, vinyltoluene, ethylene, vinyl acetate, vinyl chloride, vinylidene chloride, acrylonitrile, acrylamide, methacrylamide, C1-C12 alkyl esters of (meth)acrylic acid or mixtures thereof.

The preparation of these polymeric microparticles by emulsion polymerization and also their swelling by means of bases such as alkali or alkali metal hydroxides, for example, and also ammonia or an amine are likewise described in European patents EP 22 633 B1, EP 735 29 B1, and EP 188 325 B1.

It is possible to prepare core-shell particles which have a single-shell or multishell construction or whose shells exhibit a gradient, the composition changing from the core to the shell either in steps or in the form of a gradient.

The polymer content of the microparticles used may be situated, as a function, for example, of the diameter, the core/shell ratio, and the swelling efficiency, at 2% to 98% by weight.

In accordance with the invention the water-filled polymeric microparticles are used in the form of an aqueous dispersion. It is likewise possible within the scope of the present invention to add the water-filled microparticles directly as a solid to the building material mixture. For that purpose the microparticles are coagulated with, for example, calcium dichloride (CaCl2), and are isolated from the aqueous dispersion by methods known to the skilled worker (e.g. filtration, centrifugion, sedimentation, and decanting), and the particles are subsequently dried, as a result of which the water-containing core may well remain intact.

The water-filled microparticles are added to the building material mixture in a preferred amount of 0.01% to 5% by volume, in particular 0.1% to 0.5% by volume. The building material mixture, in the form for example of concrete or mortar, may in this case include the customary hydraulically setting binders, such as cement, lime, gypsum or anhydrite, for example.

Through the use of the microparticles of the invention it is possible to keep the air introduced into the building material mixture at an extraordinarily low level.

On concrete, for example, improvements in compressive strengths of more than 35% have been found, as compared with concrete obtained with conventional air entrainment.

Higher compressive strengths are of interest, in addition and in particular, insofar as it is possible to reduce the cement content of the concrete, which is needed for strength to develop, as a result of which it is possible to achieve a significant lowering in the price per m³ of concrete.

1. Use of polymeric microparticles, containing a void, in hydraulically setting building material mixtures, characterized in that the microparticles are stabilized by nonionic emulsifiers.

2. Use of polymeric microparticles, containing a void, according to claim 1, characterized in that the hydrophilic group of the nonionic emulsifiers used belongs to the alcohols, amine oxides or (oligo)oxyalkylenes or mixtures thereof.

3. Use of polymeric microparticles, containing a void, according to claim 2, characterized in that the nonionic emulsifiers are used in amounts of <5% by weight, based on the polymer content of the microparticles used.

4. Use of polymeric microparticles, containing a void, according to claim 2, characterized in that the nonionic emulsifiers are used in amounts of <3% by weight, based on the polymer content of the microparticles used.

5. Use of polymeric microparticles, containing a void, according to claim 2, characterized in that the nonionic emulsifiers are used in amounts of <1% by weight, based on the polymer content of the microparticles used.

6. Use of polymeric microparticles, containing a void, according to claim 1, characterized in that the microparticles are composed of polymer particles which contain a polymer core (A), swollen by means of an aqueous base and based on an unsaturated carboxylic acid (derivative) monomer, and a polymer envelope (B), based on a nonionic, ethylenically unsaturated monomer.

7. Use of polymeric microparticles, containing a void, according to claim 6, characterized in that the unsaturated carboxylic acid (derivative) monomers are selected from the group of acrylic acid, methacrylic acid, maleic acid, maleic anhydride, fumaric acid, itaconic acid, and crotonic acid.

8. Use of polymeric microparticles, containing a void, according to claim 6, characterized in that the nonionic, ethylenically unsaturated monomers are composed of styrene, butadiene, vinyltoluene, ethylene, vinyl acetate, vinyl chloride, vinylidene chloride, acrylonitrile, acrylamide, methacrylamide, C1-C12 alkyl esters of acrylic or methacrylic acid.

9. Use of polymeric microparticles, containing a void, according to claim 1, characterized in that the microparticles have a polymer content of 2% to 98% by weight.

10. Use of polymeric microparticles, containing a void, according to claim 1, characterized in that the microparticles possess an average particle size of 100 to 5000 nm.

11. Use of polymeric microparticles, containing a void, according to claim 1, characterized in that the microparticles possess an average particle size of 200 to 2000 nm.

12. Use of polymeric microparticles, containing a void, according to claim 1, characterized in that the microparticles possess an average particle size of 250 to 1000 nm.

13. Use of polymeric microparticles, containing a void, according to claim 1, characterized in that the microparticles are used in an amount of 0.01% to 5% by volume, based on the building material mixture.

14. Use of polymeric microparticles, containing a void, according to claim 1, characterized in that the microparticles are used in an amount of 0.1% to 0.5% by volume, based on the building material mixture.

15. Use of polymeric microparticles, containing a void, according to claim 1, characterized in that the building material mixtures are composed of a binder selected from the group of cement, lime, gypsum and anhydrite.

16. Use of polymeric microparticles, containing a void, according to claim 1, characterized in that the building material mixtures are concrete or mortar.
